(19) United States
(12) Patent Application Publication
(10) Pub. No.: US 2007/0188088 A1
(43) Pub. Date: Aug. 16, 2007

(54) Image display apparatus

(76) Inventor: Mutsumi Suzuki, Kodaira (JP)

Correspondence Address: MILES & STOCKBRIDGE PC, 1751 PINNACLE DRIVE, SUITE 500, MCLEAN, VA, 22102-3833, US

(21) Appl. No.: 11/655,137

(22) Filed: Jan. 19, 2007

(30) Foreign Application Priority Data
Jan. 27, 2006 (JP) 2006-018364

(51) Int. Cl. H01J 1/62

(52) U.S. Cl. 313/506

(57) ABSTRACT

In a planar display apparatus having electron-emitter elements, phosphors, and spacers in combination, occurrence of vacuum discharge such as arc discharge or spark discharge is reduced and after images are reduced in the display apparatus by using a thin-film electron emitter, in which an electron-emitter elements are operated before starting-up of image display and a phosphor-application voltage during the operation is set to a non-light emitting voltage.

### CLAIM OF PRIORITY

The present application claims priority from Japanese application JP 2006-018364 filed on Jan. 27, 2006, the content of which is hereby incorporated by reference into this application.

### FIELD OF THE INVENTION

The present invention concerns a display apparatus for displaying images by using electron-emitter elements and phosphors arranged in a matrix.

### BACKGROUND OF THE INVENTION

In a matrix electron-emitter display, intersections between groups of electrodes perpendicular to each other are defined as pixels, an electron-emitter element is disposed to each pixel, the amount of emitted electrons is controlled by controlling an applied voltage or a pulse width of pulses applied to each of the electron-emitter elements, the emitted electrons are accelerated in vacuum and then bombarded on the phosphor to emit light from the phosphor at the bombarded portion. The electron-emitter element includes those using a field emission type cathode, those using an MIM (Metal-Insulator-Metal) cathode, those using a carbon nanotube cathode, those using a diamond cathode, those using a surface-conduction electron-emitter element, and those using a ballistic electron surface-emitting electron source. As described above, the matrix electron emitter display means a cathode luminescent flat-panel display having an electron-emitter element and a phosphor in combination.

As shown in FIG. 2, in the matrix electron-emitter display, a cathode plate 601 on which electron-emitter elements are arranged and a phosphor plate 602 on which phosphor are formed are opposed to each other. A space between the cathode plate and the phosphor plate is kept in vacuum so that electrons emitted from the electron-emitter elements 301 reach the phosphor plate and excite the phosphor to emit light. For withstanding an atmospheric pressure from the outside, a spacer (support post) 60 is inserted between the cathode plate and the phosphor plate.

The phosphor plate 602 has an acceleration electrode 122, and a high voltage at about 3 KV to 10 KV is applied to the acceleration electrode 122. Electrons emitted from the electron-emitter elements 301 are accelerated by the high voltage and then bombarded to the phosphor thereby exciting the phosphor to emit light.

Further, in the present specification, the thin-film electron-emitter has a structure of stacking a top electrode, an electron acceleration layer, and a base electrode and includes, for example, an MIM (Metal-Insulator-Metal) cathode, an MOS (Metal-Oxide-Semiconductor) electron source, and a ballistic electron surface-emitting electron source. The MOS electron emission source uses a semiconductor-insulator stacked film for the electron acceleration layer which is described, for example, in Japanese Journal of Applied Physics, Vo. 36, Part 2, No. 7B, pp. L939-L941 (1997). The ballistic surface electron emission source uses porous silicon or the like for the electron acceleration layer which is described, for example, in Japanese Journal of Applied Physics, Vo. 34, Part 2, No. 6A, pp. L705-L707 (1995). The thin-film electron emitter emits electrons accelerated in the electron acceleration layer into vacuum.

### SUMMARY OF THE INVENTION

The matrix electron emitter display involves a problem that discharge occurs between the phosphor plate 602 and the cathode plate 601 by the phosphor screen voltage applied to the phosphor plate 602. The invention intends to provide a display apparatus of reducing the discharge.

In a matrix electron emitter display using the thin-film electron emitter, a phenomenon that the brightness changes gradually within a short period of time after switching from display images at a low luminosity to display images at a high luminosity has been observed. This is recognized to the human eyes as after images. “Short period time” means herein a range from several seconds to several minutes.

The invention intends to provide a display apparatus of reducing the after images.

The outline of typical examples among those disclosed in the present application is to be simply described as below.

A display apparatus including a display panel having a first substrate having a first group of plural electrodes parallel with each other and a second group of plural electrodes parallel with each other and crossing the first group of electrodes and a plurality of electron-emitter elements and a second substrate having phosphors and acceleration electrodes, and voltage supply means for supplying a phosphor screen voltage to the acceleration electrodes, in which the apparatus has a first step and a second step upon starting an image display operation of the display apparatus, the phosphor screen voltage is set lower in the first step than the phosphor screen voltage in the second step, electrons are emitted from the plurality of electron-emitter elements in the first step, the phosphor screen voltage is set to 3 kV or higher in the second step, electrons are emitted in accordance with image signals to be displayed from the electron-emitter elements, and the first step is conducted prior to the second step in view of time.

A display apparatus including a display panel having a first substrate having a first group of plural electrodes parallel with each other and a second group of plural electrodes parallel with each other and crossing the first group of electrodes and a plurality of electron-emitter elements and a second substrate having phosphors and acceleration electrodes, and voltage supply means for supplying a phosphor screen voltage to the acceleration electrode, in which the apparatus has a first step and a second step upon starting an image display operation of the display apparatus, the phosphor screen voltage is set lower in the first step than the phosphor screen voltage in the second step, electrons are emitted from the plurality of electron-emitter elements, the phosphor screen voltage is set to 3 kV or higher, and electrons are emitted in accordance with image signals to be displayed from the electron-emitter elements in the second step, and the first step is conducted prior to the second step in view of time, and the apparatus has a third step between the first step and the second step, and stops the electron emission from the plurality of electron-emitter elements in the third step.

A display apparatus including a display panel having a first substrate having a base electrode, an electron acceleration layer, and a top electrode and having a plurality of thin-film electron emitters for emitting electrons from the surface of the top electrode upon application of a voltage at such a polarity that the top electrode is at a positive voltage relative to the base electrode between the base electrode and the top electrode, and having a first group of a plurality of electrodes parallel with each other and a second group of a plurality of electrodes parallel with each other and crossing the first group of electrodes and a second substrate having phosphors and acceleration electrodes, and voltage supply means for supplying a phosphor screen voltage to the acceleration electrode, in which the apparatus has a first step and a second step upon starting an image display operation of the display apparatus, the phosphor screen voltage is set lower in the first step than the phosphor screen voltage in the second step, electrons are emitted from the plurality of the thin-film electron emitters, the phosphor screen voltage is set to 3 kV or higher, and electrons are emitted in accordance with image signals to be displayed from the thin-film electron emitters in the second step, and the first step is conducted prior to the second step in view of time.

A display apparatus including a display panel having a first substrate having a first group of a plurality of electrodes parallel with each other and a second group of electrodes parallel with each other and crossing the first group of the electrodes and a plurality of electron-emitter elements, and a second substrate having phosphors and acceleration electrodes, and voltage supply means for supplying a phosphor-screen voltage to the acceleration electrode, in which upon starting the image display operation of the display apparatus, electrons are emitted from the plurality of electron-emitter elements with a finite delay time after supply of the phosphor screen voltage to the acceleration electrodes.

A method of reducing discharge between the phosphor plate and the cathode plate in the matrix electron emitter display is to be described along with preferred embodiments. A method of reducing after images in the matrix electron emitter display using the thin-film electron emitter is to be described herein.

FIG. 3 is an energy band diagram showing the operation principle of the thin-film electron emitter. The diagram shows a state in which a base electrode 13, an electron acceleration layer 12, and a top electrode 11 are stacked and a positive voltage is applied to the top electrode 11. In a case of an MIM cathode, an insulator is used as the electron acceleration layer 12. An electric field is generated in the electron acceleration layer 12 by the voltage applied between the top electrode and the base electrode. By the electric field, electrons flow from the inside of the base electrode 13 into the electron acceleration layer 12 by a tunneling phenomenon. The electrons are accelerated by the electric field in the electron acceleration layer 12, and become hot electrons. Upon passage of the hot electrons in the top electrode 11, a portion of the electrons loses the energy by inelastic scattering or the like. Upon reaching the interface between the top electrode and vacuum, (that is, at the surface of the top electrode), electrons having a larger kinetic energy than the work function φ are emitted in vacuum. In the present specification, the current flowing by the hot electrons between the base electrode 13 and the top electrode 11 is referred to as a diode current Id and the current emitted in vacuum is referred to as an emission current Ie. Then, the ratio (Ie/Id) between the diode current Id and the emission current Ie is referred to as electron-emission ratio.

As a result of detailed measurement and study on the electron emission characteristics of the thin-film electron emitter, the present inventor has found that the after image phenomenon is generated by the following mechanism.

FIG. 4 is an energy-band diagram of the thin-film electron emitter after operation for a while in a high brightness state. Upon passage of the hot electrons that form the diode current through the electron acceleration layer, a portion of the electrons is trapped in the electron acceleration layer. The trapped electrons 711 form an internal electric field inside the electron acceleration layer. As shown in FIG. 4, the electric field intensity at the interface between the base electrode 13 and the electron acceleration layer 12 is weakened by the internal electric field. Accordingly, the amount of electrons flowing from the base electrode into the electron acceleration layer, that is, the diode current Id decreases. In accordance with the decrease the emitted current Ie=α×Id decreases and the brightness somewhat lowers. This is the after image phenomenon.

Further, the present inventor has found that the after image phenomenon is particularly remarkable in the thin-film electron emitter, the electron emission operation of which has been stopped for a long time. This is because electric charges trapped in the electron acceleration layer are decreased by discharging and dissipating when the electron emission operation has been stopped for a long time.

According to the invention, occurrence of vacuum discharge such as arc discharge or spark discharge can be reduced. Further, according to the invention, after images can be decreased in the display apparatus using the thin-film electron emitter for the electron-emitter element.

The display apparatus according to the invention is to be described more in details with reference to the preferred embodiments of the invention by way of several embodiments.

### DESCRIPTION OF THE ACCOMPANYING DRAWINGS

FIG. 1 is a diagram showing an operation sequence upon starting-up the image displaying operation of a display apparatus according to the invention;

FIG. 2 is a schematic view showing a cross section of a matrix electron source display;

FIG. 3 is a view for explaining an electron emission mechanism of a thin-film electron emitter;

FIG. 4 is a view for explaining after image phenomenon of the thin-film electron emitter;

FIG. 5 is a plan view for explaining the structure of a display panel in the first embodiment of a display apparatus according to the invention;

FIG. 6 is a cross sectional view for explaining the structure of a display panel in the first embodiment of a display apparatus according to the invention;

FIG. 7 is a plan view showing a portion of a cathode plate of the first embodiment of a display apparatus according to the invention;

FIG. 8 is a cross sectional view showing a portion of a cathode plate of the first example of a display apparatus according to the invention;

FIG. 9 is a view for explaining a process for preparing a cathode plate of the first example of a display apparatus according to the invention;

FIG. 10 is a view showing connection between a display panel and a driving circuit in the first embodiment of a display apparatus according to the invention ; and

FIG. 11 is a view showing a driving method of the first embodiment of a display apparatus according to the invention.

### DESCRIPTION OF THE PREFERRED EMBODIMENTS

### First Embodiment

A first embodiment using the invention is to be described.

In the embodiment, a thin-film electron emitter is used as an electron-emitter element 301. More specifically, an MIM (Metal-Insulator-Metal) cathode is used.

FIG. 5 is a plan view of a display panel used in this embodiment. FIG. 6 is a cross sectional view along line A-B in FIG. 5.

The inside surrounded with a cathode plate 601, a phosphor plate 602, and a frame component 603 is evacuated. Spacers 60 for withstanding an atmospheric pressure are placed in a vacuum region. The shape, the number, and the placement of the spacers 60 are optional. Scan electrodes 310 are placed horizontally on the cathode plate 601, and data electrodes 311 are arranged in perpendicular thereto. Intersections between the scan electrodes 310 and the data electrodes 311 correspond to pixels. The pixel corresponds to a sub-pixel in the case of the color display apparatus.

In FIG. 5, while the scan electrodes 310 are shown only by the number of twelve, they are in the number of from several hundreds to several thousands in an actual display. It is also identical for the data electrodes 311. Electron emission elements 301 are arranged at the intersections between the scan electrodes 310 and the data electrodes 311.

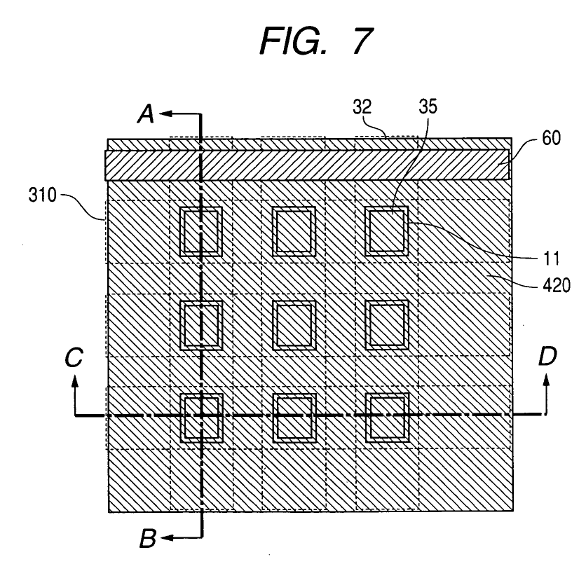

FIG. 7 is a plan view showing a portion of the cathode plate 601 in FIG. 5. All areas other than the electron-emission region 35 emitting electrons in vacuum and the top electrodes 11 are substantially covered with a common electrode 420. The bottom of the spacer 60 is in contact with the common electrode 420. Since the scan electrodes 310 and the top electrode bus lines 32 (also serving as the data electrodes 311 in this embodiment) are covered with the common electrode and do not appear in the plan view, they are shown by dotted lines.

In this embodiment, a thin-film electron emitter is used as the electron-emitter element 301. The electron emission regions 35 (region surrounded with the dotted line) are present at the region where the scan electrodes 310 and the top electrode bus lines 32 intersect and electrons are emitted from the region.

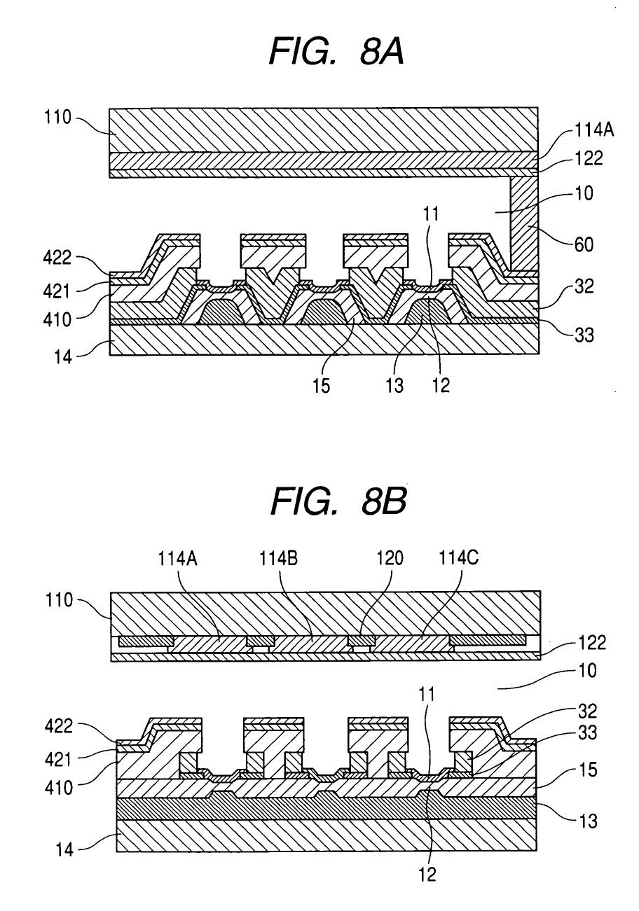

FIG. 8 is a cross sectional view of a display panel used in this embodiment. FIG. 8A is a cross sectional view along line A-B in FIG. 7 and FIG. 8B is a cross sectional view along line C-D in FIG. 7.

The constitution of a cathode plate 601 is as described below. A thin-film electron-emitter 301 (electron-emitter element 301 in this embodiment) comprising a base electrode 13, an insulator 12, and a top electrode 11 is constituted above an insulative substrate 14 such as made of glass. The top electrode bus lines 32 are electrically connected by way of top electrode bus line under-layer film 33 to the top electrodes 11 and act as a current feeding line to the top electrode 11. Further, in this embodiment, the top electrode bus lines 32 operate as the data electrodes 311.

A region where the electron-emitter elements 301 are arranged in a matrix (referred to as a cathode region 610) on the cathode plate 601 is covered with an inter-layer insulating film 410, on which the common electrode 420 is formed. The common electrode 420 comprises a stacked film of a common electrode film A 421 and a common electrode film B 422.

The common electrode is connected to the ground potential. The spacer 60 is in contact with the common electrode 420 and acts to flow the current flowing from the acceleration electrode 122 of the phosphor plate 602 by way of the spacer 60 and acts to flow electric charges charged in the spacer 60.

In FIG. 8, the scale reduction size in the direction of the height is optional. That is, while the thickness of the base electrode 13 or the top electrode bus line 32, etc. is several μm or less, the distance between the substrate 14 and the front plate 110 has a length of about 1 to 3 mm.

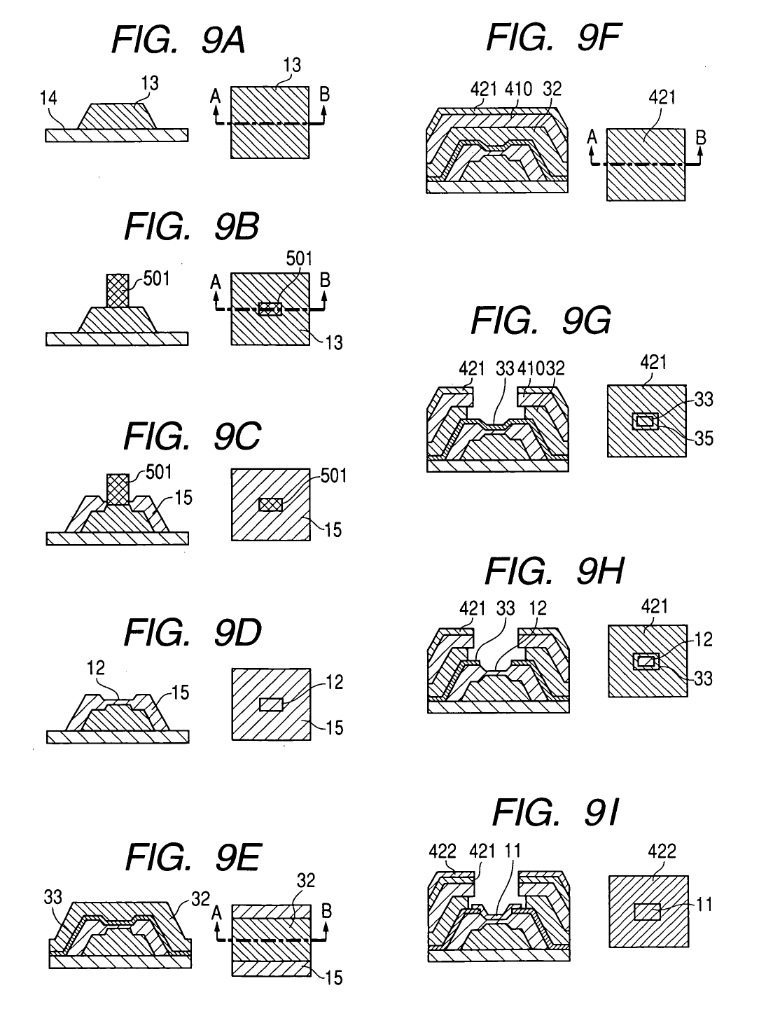

A method of preparing the cathode plate 601 is to be described with reference to FIG. 9. FIG. 9 shows a process of preparing a thin-film electron emitter on a substrate 14. In FIG. 9, only one electron-emitter element formed at an intersection of one of the scan electrode 310 and one of data electrodes 311 is taken out and drawn. In FIG. 9, each drawing of the right column is a plan view, and each of the left column is a cross sectional view along line A-B in the drawing.

An Al alloy is formed as a material for the base electrode 13, for example, to a film thickness of 300 nm on an insulative substrate 14 such as made of glass. An Al—Nd alloy is used in this case. For forming the Al alloy film, a sputtering method, a resistive-heating evaporation method or the like is used. Then, the Al alloy film is fabricated into a stripe form by resist formation by photolithography and subsequent etching to form a base electrode 13. Any resist may be used so long as it is suitable to etching and any of wet etching or dry etching is possible for the etching. This is a state shown in FIG. 9A.

Then, a resist is coated and exposed with UV-rays to be patterned thereby forming a resist pattern 501 shown in FIG. 9B. For the resist, for example, a quinone diazide positive resist is used. Then, anodization is conducted while attaching the resist pattern 501 as it is to form a protection layer 15. For the anodization, an anodization voltage is set at about 100 V and thus the thickness of the protection layer 15 is about 140 nm in this embodiment. This state is shown in FIG. 9C.

After removing the resist pattern 501, the surface of the base electrode 13, which has been covered with the resist is anodized to form an insulator 12. In this embodiment, the anodization voltage is set to 6V and thus the thickness of the insulator is 8 mm. This is a state shown in FIG. 9D. The region formed with the insulator 12 is an electron emission region 35. That is, the region surrounded with the protection layer 15 is the electron-emission region 35.

Then, after forming the film of a top electrode bus line under-layer film 33 and top electrode bus lines 32, they are patterned to form the top electrode bus lines 32. The top electrode bus lines 32 also serve as the data electrodes 311. This is a state shown in FIG. 9E. In this embodiment, the top electrode bus line under-layer film 33 is a tungsten film of about 10 nm thickness and the top electrode bus line 32 is an Al alloy of about 300 nm thickness. Au or the like may also be used as the material for the bus line 32.

Then, the inter-layer insulative film 410 and a common electrode film A 421 are deposited (FIG. 9F). As the material for the inter-layer insulative film 410 and the common electrode film A 421, a combination of materials that can be etched simultaneously may be used preferably. For example, Si₃N₄ is used as the inter-layer insulative film 410, and tungsten, molybdenum, titanium or the like is used for the common electrode film A 421.

Then, the electron-emission region 35 and the inter-layer insulative film at the periphery thereof are opened by etching. Then, the top electrode bus line 32 is also etched to form an opening (FIG. 9G). The opening for the top electrode bus line 32 is made larger than the opening for the inter-layer insulative film 410 by properly setting the etching condition. By fabricating the opening portion into “overhung-like shape”, electrical isolation between the upper electrodes of electron-emitter elements is made reliable in the subsequent step.

The top electrode bus line under-layer film 33 is etched by the pattern in FIG. 9H to expose the insulator 12. Finally, the top electrode 11 is deposited by sputtering or the like. In the top electrode material, a portion deposited on the insulator 12 acts as the top electrode 12. On the other hand, the top electrode material deposited on the common electrode film A 421 forms a common electrode film B 422. This acts as the common electrode 420.

For top electrode 11, a conductive film of about 10 nm thickness is used. In this embodiment, a stacked film of iridium (Ir), platinum (Pt), and gold (Au) is deposited to a total thickness of 6 nm.

As described above, since the inter-layer insulative film 410 is formed into the “overhung-like shape”, the top electrode 11 for each of the electron-emitter elements is electrically disconnected from the common electrode 420. Accordingly, it is not necessary to pattern the top electrode 11 by etching or the like. Accordingly, the electron-emitter element 301 is free from surface contamination with chemical reagents used in an etching process, and thus the electron emission characteristic of the electron-emitter element 301 is not degraded.

The top electrode 11 and the top electrode bus line 32 are electrically connected by way of the top electrode bus line under layer film 33. Since the top electrode bus line under-layer film 33 is as thin as about 10 nm, electrical connection can be obtained reliably even with a thin top electrode 11.

A cathode plate 601 of the constitution shown in FIG. 8 is obtained by the steps described above.

The constitution of a phosphor plate 602 is as described below. A black matrix 120 is formed to a transparent front plate 110 such as made of glass and, further, a red phosphor 114A, a green phosphor 114B, and a blue phosphor 114C are formed. Further, an acceleration electrode 122 is formed. The acceleration electrode 122 is formed with an aluminum film of about 70 nm to 100 nm thickness, and electrons emitted from the thin-film electron emitter 301 are accelerated by an acceleration voltage applied to the acceleration electrode 122 and when they are incident on the acceleration electrode, they transmit the acceleration electrode and hit against the phosphor 114 to emit light from the phosphor. Details for the method of preparing the phosphor plate 602 are described, for example, in JP-A No. 2001-83907

Between the cathode plate 601 and the phosphor plate 602., the spacers 60 are placed by an appropriate number. As shown in FIG. 5, the cathode plate 601 and the phosphor plate 602 are sealed while putting the frame component 603 therebetween. Further, the space 60 surrounded with the cathode plate 601, the phosphor plate 602, and the frame component 603 is pumped to vacuum.

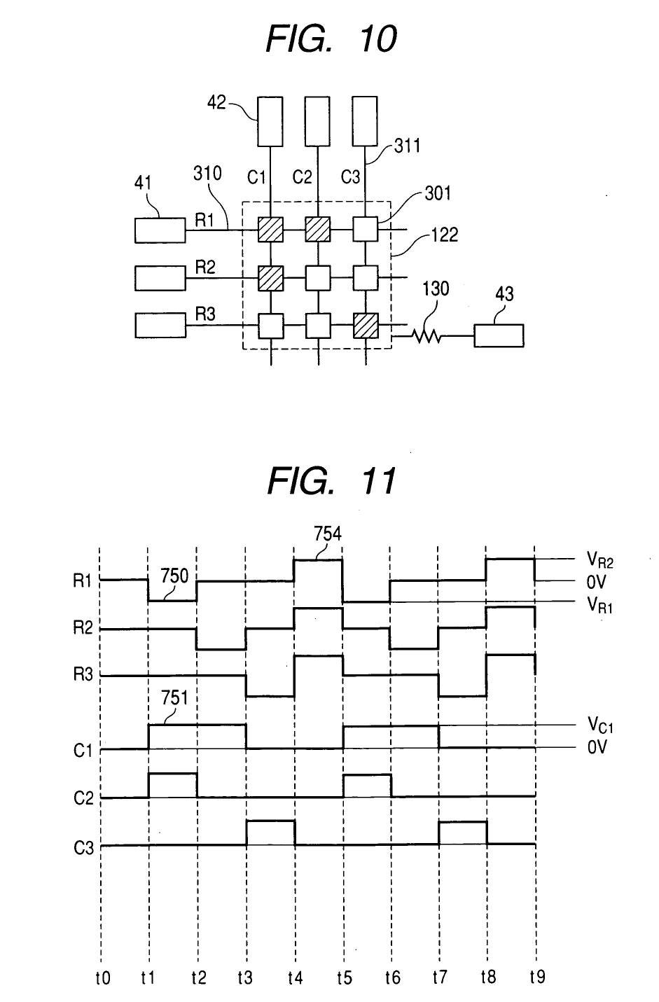

FIG. 10 is a connection diagram of the thus manufactured display panel 100 to a driving circuit. The scan-electrodes 310 are connected to scan electrode driving circuits 41, and the data electrodes 311 are connected to data electrode driving circuits 42. The acceleration electrode 122 is connected by way of a resistor 130 to an acceleration electrode driving circuit 43. A dot at an intersection between an n-th scan electrode 310 Rn and an m-th data electrode 311 Cm is represented as (n, m).

The resistance value of the resistor 130 is set as described below. For example, in a display apparatus with a diagonal size of 51 cm (21 inch), the display area is 1240 cm². In a case of setting the distance to 2 mm between the acceleration electrode 122 and the cathode, the electrical capacitance Cg between the acceleration electrode 122 and the cathode is about 550 pF. The resistor 130 may be set to 900 Ω or higher in order to obtain a time constant sufficiently longer than the generation time of vacuum discharge (about 20 nsec). It is set to 18 kΩ in this embodiment to make the time constant 10 μs.

FIG. 11 shows a waveform of a generated voltage in each of the driving circuits. While not depicted in FIG. 11, a voltage at about 3 to 10 kV is applied to the acceleration electrode 122 (phosphor screen voltage Va).

At time t0, since each of the electrodes is at a voltage of 0, electrons are not emitted and, accordingly, phosphor 114 does not emit light.

At time t1, a scan pulse 750 at a voltage of VR1 is applied to a scan electrode 310R1 and a data pulse 751 at a voltage of +VC1 is applied to the data electrodes 311C1, C2. Since a voltage at (VC1-VR1) is applied between the lower electrode 13 and the upper electrode at dots (1, 1), (1, 2), electrons are emitted in vacuum 10 from the thin-film electron emitters of the two dots when (VC1-VR1) is set to higher than a threshold voltage for electron emission. In this example, VR1=−5 V and VC1=4.5 V. The emitted electrons are accelerated by a voltage applied to the acceleration electrode 122 and then hit against the phosphor 114 to emit light from the phosphor 114.

At time t2, when a voltage at VR1 is applied to the scan electrode 310R2 and a voltage at VC1 is applied to the data electrode 311C1, the dot (2, 1) is also lit. Further, at time t3, when a voltage at VR1 is applied to the scan-electrode 310R3 and voltage at VC1 is applied to the data electrode 311C3, the dot (3, 3) is lit in the same manner. As described above, when the voltage waveform shown in FIG. 11 is applied, only the hatched dots in FIG. 10 are lit.

As described above, desired image or information can be displayed by changing the signals applied to the data electrode 311. Further, images with gray scale can be displayed by properly changing the amplitude of the applied voltage VC to the data electrodes 311 in accordance with the image signals.

As shown in FIG. 11, at time t4, a voltage at VR2 is applied to the all scan electrodes 310. In this example, VR2=5 V. Since the applied voltage to all data electrodes 311 is at 0 V, a voltage at −VR2=−5 V is applied to the thin-film electron emitter 301. By applying the voltage with reverse polarity (reverse pulse 754) relative to that upon electron emission, the life time characteristics of the thin-film electron emitter can be improved. Further, for the period of applying the reverse pulse (t4-t5 and t8-t9 in FIG. 11), a vertical blanking period of the video signals can be used, which results in good matching with the video signals.

In the description for FIG. 10 and FIG. 11, while description has been made by using an example of 2×3 dots for the sake of simplicity, the number of scanning electrodes ranges from several hundreds to several thousands and the number of the data electrodes also ranges from several hundreds to several thousands in actual display apparatus.

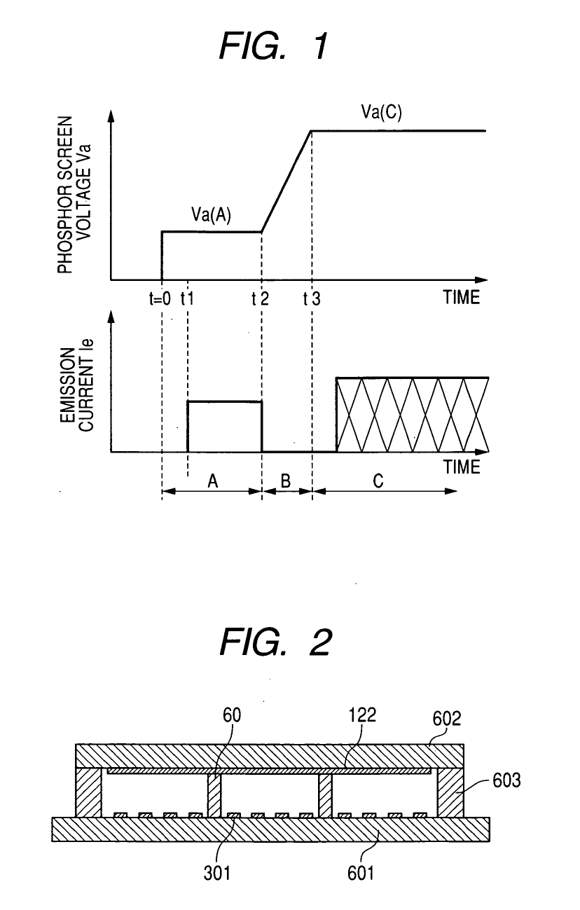

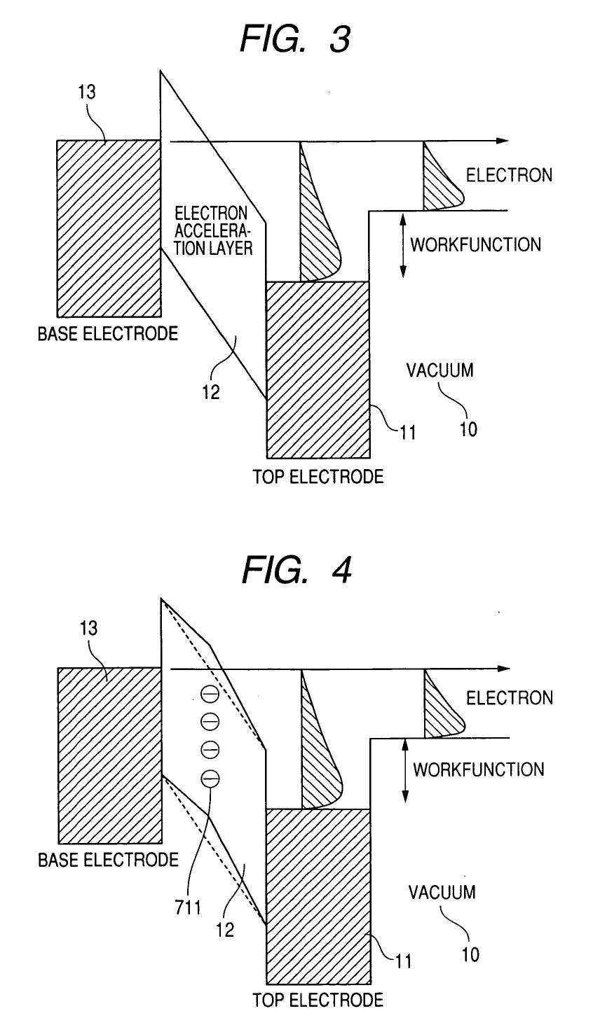

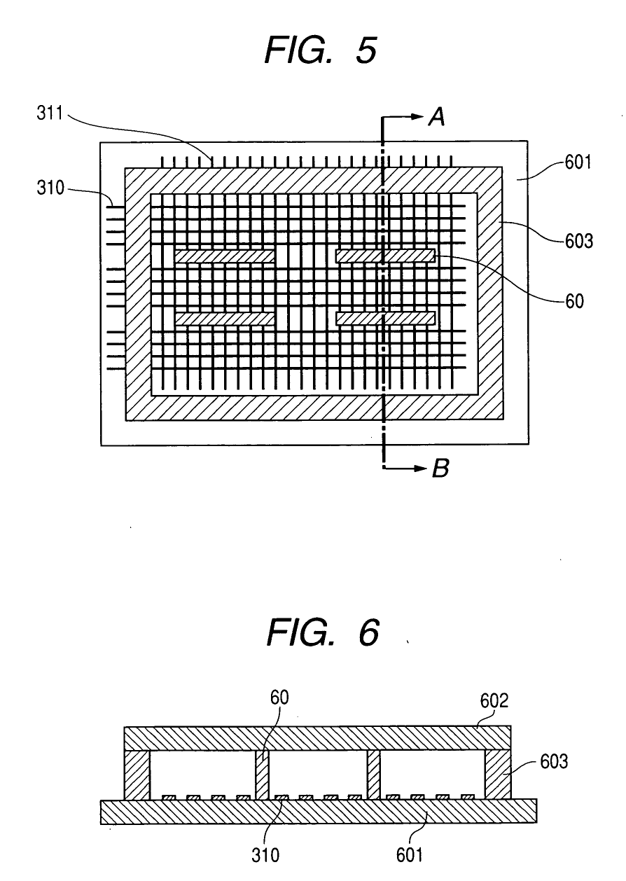

In the foregoing explanation, an operation method for a stationary operation period has been described in which images or information are displayed on the display apparatus. Then, a start-up sequence of starting the display operation for the display apparatus whose operation has been stopped is to be described with reference to FIG. 1.

“Upon starting the display operation for the display apparatus” specifically means the instance at which a user turns on a power switch or turns on a display operation start-up switch for viewing a television display images (more precisely, a period from the turn-on of the switch till the operation of the stationary image display operation) at a user's place of use such as a home or office in a case of using the display apparatus, for example, as a television receiver.

When the switch for the image display apparatus is turned on at time t=0, the phosphor screen voltage Va is set to Va (A) The set voltage Va (A) is set to a voltage at which the phosphor screen does not emit light. It is usually set to: Va (A)=about 500 V to 3 kV. Then, the electron-emitter elements are operated from time t1 for a period where the phosphor screen voltage is set to Va (A) (that is, up to time t2). An average emission current for the period: t=t1 to t2 is defined as Ie(A).

The phosphor screen voltage Va is increased from Va (A) to Va (C) in the period: time t=t2 to t3 (period B). The voltage Va (C) is a phosphor screen voltage upon conducting stationary display operation which is usually set to about Va (C)=3 to 10 kV. In the period B, the operation of the electron-emitter element is once stopped. By stopping the electron emission till the phosphor screen voltage is stabilized to a constant voltage, distorted images, etc. are prevented from being displayed; therefore, this provides a more preferred mode.

After setting the phosphor screen to voltage Va (C) at time t3, the electron-emitter elements are operated in accordance with image signals to display images. In FIG. 1, the operation start-up for the electron-emitter elements is somewhat delayed from time t3 so that images are displayed after the phosphor-screen voltage is stabilized to Va (C). In this embodiment, the delay time is set to 1 sec.

A matrix electron-emitter display involves a problem that discharge occurs between the phosphor plate 602 and the cathode plate 601, and such discharge often occurred just after the start of the image display operation by switching on the display apparatus. This is because adsorbed materials in the display panel are released as gases in the panel by starting the electron emission and they collide with the electron and are ionized thereby leading to discharge. By using the sequence shown in FIG. 1, since the phosphor screen voltage is set low just after turning-on the switch (period A), even when gases are generated in the panel it does not lead to discharge.

Further, in the period A, since the phosphor-screen voltage Va (A) is set to such a voltage that the phosphor does not emit light, it is not displayed as images and, accordingly, does not cause a trouble that unnecessary images are displayed. It is preferred to set Va (A) such that the luminous efficiency at the phosphor screen upon application of the phosphor-screen voltage Va (A) is ⅕ or less of the luminous efficiency upon application of Va (C), since unnecessary images are reduced to an acceptable level. It is further preferred to set the luminous efficiency at the phosphor screen upon application of the phosphor-screen voltage Va (A) to 1/10 or less of the luminous efficiency upon application of Va (C), since the displayed images in the period A is made further invisible.

With the reasons described below, application of the phosphor-screen voltage before the start-up of the operation of the electron-emitter elements is preferred. That is, the electron emitter elements are operated after the application of the phosphor-screen voltage or with some delay time t1 (t2>0) to the acceleration electrode 122.

In a case of operating the electron-emitter element in a state where the phosphor-screen voltage is at zero (V), while the emitted electrons are emitted in vacuum of the display panel 100, they are not captured to the acceleration electrode 122. The emitted electrons are deposited to an insulator or the dielectric portion, or contaminated particles in the panel to cause electric charge. When a high voltage is applied to the acceleration electrode 122 in this state, vacuum discharge tends to occur.

By electrically charging the surface contaminants of the electron-emitter elements, the electron emission characteristics of the electron-emitter elements may sometimes be degraded. By adopting the sequence of applying the phosphor-screen voltage before the operation of the electron-emitter elements, such problems can be overcome. In this embodiment, it is set as: t1=0.5 sec.

As apparent from the reasons described above, application of the phosphor-screen voltage before the operation of the electron-emitter elements is effective not only in a case of applying the phosphor-screen voltage stepwise as periods A, B, and C.

Also in a case of applying the phosphor-screen voltage stepwise as period A, B, and C, when the electron-emitter elements are operated in the period A with lapse of a delay time t1 after application of the phosphor-screen voltage Va (A) (that is t1>0), the effect of preventing vacuum discharge is further improved preferably. In this example, it is set as: t1=0.5 sec.

While the length for the periods A and B can be set optionally, it is typically set at t2=1 to 4 sec, (t3−t1)=about 1 to 3 sec.

In the embodiments described above, while description has been made to a case of using the thin-film electron emitter as the electron-emitter element 301, it will be apparent that the invention is effective also in a case of using other electron sources as the electron-emitter elements.

Since the purpose of the period A is to release the adsorption gas thereby reducing the subsequent generation of electric discharge, it is more effective to operate all the electron-emitter elements in the period: t=t1 to t2.

### Second Embodiment

In this embodiment, description is to be made for the embodiment of decreasing after images which was the problem present so far in the display apparatus using the thin-film electron emitter.

The structure, manufacturing method and the wiring method to the driving circuit of the display panel used in this embodiment are identical with those in the first embodiment. Also the application voltage upon display operation for the images in accordance with image signals is as shown in FIG. 11 which is identical with the first embodiment.

Then, a start-up operation sequence upon starting the display operation of the display apparatus whose operation has been stopped is to be described with reference to FIG. 1.

When a switch of a display apparatus is turned on at time t=0, the phosphor-screen voltage Va is at first set to Va (A). The setting voltage Va (A) is set to such a voltage that the phosphor-screen does not emit light. It is usually set to about: Va (A)=500 V to 3 kV. Then, the electron-emitter element are operated for a period from time t1 for a period where the phosphor-screen voltage is set to Va (A) (that is, up to time t2) An average emitting current during the period: t=t1 to t2 is defined as Ie (A).

At the period: time t=t2 to t3 (period B), the phosphor-screen voltage Va is increased from Va (A) to Va (C). The voltage Va (C) is a phosphor-screen voltage upon conducting a stationary display operation, which is usually set to about: Va (C)=3-10 kV. In the period B, the operation of the electron emitter elements is once stopped. By stopping the electron emission till the phosphor-screen voltage is settled to a constant voltage as described above, distorted images, etc. are prevented from being displayed; therefore, this provides more preferred mode.

After setting the phosphor-screen voltage to Va (C) at time t3, the electron-emitter elements are operated in accordance with image signals to conduct image display. In FIG. 1, the operation start-up of the electron-emitter elements is delayed somewhat from time t3 so that images are displayed after the phosphor-screen voltage is stabilized to Va (C). In this embodiment, the delay time is set to 1 sec.

By the operation in accordance with the operation sequence in FIG. 1, since the electron-emitter elements have been operated in the period A prior to the start-up of image display, images with decreased afterimages can be displayed from the beginning of the image display operation at time t3. Further, in the period of A, while electrons are emitted from the electron-emitter elements, since the phosphor-screen voltage Va (A) is set to such a voltage that the phosphor-screen does not emit light, they are not displayed as images.

It is preferred to set Va (A) such that the luminous efficiency at the phosphor screen upon application of the phosphor-screen voltage Va (A) is ⅕ or less of the luminous efficiency upon application of Va (C), since unnecessary images are reduced to an acceptable level. It is more preferred to set the luminous efficiency at the phosphor screen upon application of the phosphor-screen voltage Va (A) to 1/10 or less of the luminous efficiency upon application of Va (C), since the displayed images in the period A is made further invisible.

Since it is intended to utilize the period A, by operating electron-emitter elements in advance, to decrease the afterimage level in the period of displaying image signals (period (C)), it is more effective when all the electron-emitter elements are operated in the period A.

Further, since the effect of this embodiment is to accumulate electric charges beforehand in the traps in the electron acceleration layer 12 of the thin-film electron emitter, a further effect can be obtained when the intensity of the signals for driving the thin-film electron emitter in the period A is increased to some extent. Actually, more effect can be obtained when setting the application voltage (to the thin-film electron emitter) in the period A so as to flow a emission current of 50% or more of the maximum emission current value Ie (max) emitted from the thin-film electron emitter during image display operation.

While the length for the period A, B can be set optionally, it is typically set as t2=2 to 4 sec, (t3−t2)=about 1 to 3 sec.

What is claimed is:

1. A display apparatus including a first substrate having a plurality of electron-emitter elements, and a second substrate having phosphors and accelerations electrode, and voltage supply means for supplying a phosphor screen voltage to the acceleration electrodes, in which
the apparatus has a first step and a second step upon starting an image display operation of the display apparatus,
the phosphor screen voltage is set lower in the first step than the phosphor screen voltage in the second step,
electrons are emitted from the plurality of electron-emitter elements in the first step,
the phosphor screen voltage is set to 3 kV or higher in the second step and electrons in accordance with image signals to be displayed are emitted from the electron-emitter elements, and
the first step is conducted prior to the second step in view of time.

2. A display apparatus according to claim 1, wherein
the apparatus has a third step between the first step and the second step, and
the electron emission from the plurality of electron-emitter elements is stopped in the third step.

3. A display apparatus according to claim 1, wherein
the phosphor screen voltage in the first step is set such that the luminous efficiency at the phosphor screen in the first step is ⅕ or less of the luminous efficiency at the phosphor screen in the second step.

4. A display apparatus according to claim 1, wherein
the phosphor screen voltage in the first step is set such that the luminous efficiency at the phosphor screen in the first step is 1/10 or less of the luminous efficiency at the phosphor screen in the second step.

5. A display apparatus according to claim 1, wherein
all the electron-emitter elements are operated in the first step.

6. A display apparatus according to claim 1, wherein
the operation of emitting electrons from the plurality of electron-emitter elements is started with a finite delay time after application of the phosphor screen voltage in the first step.

7. A display apparatus according to claim 6, wherein
the delay time is 0.5 sec or more.

8. A display apparatus according to claim 1, wherein
the electron-emitter element is a thin-film electron emitter having a base electrode, an electron acceleration layer, and a top electrode.

9. A display apparatus according to claim 8, wherein
the emission current emitted from the electron-emitter element in the first step is one-half or more of the emission current emitted from the electron-emitter element at the highest brightness during image display operation.

10. A display apparatus including display panel having a first group of a plurality of electrodes parallel with each other and a second group of electrodes parallel with each other and crossing the group of the first electrodes,
a display panel having a first substrate having plurality of electron-emitter elements and a second substrate having phosphors and acceleration electrodes, and voltage supply means for supplying a phosphor-screen voltage to the acceleration electrodes, in which
upon starting the image display operation of the display apparatus, electrons are emitted from the plurality of electron-emitter elements with a finite delay time after supply of the phosphor screen voltage to the acceleration electrodes.

11. A display apparatus according to claim 10, wherein the delay time is 0.5 sec or more.

12. A display apparatus according to claim 10, wherein
the electron-emitter element is a thin-film electron emitter having a base electrode, an electron acceleration layer, and a top electrode.
